(19) United States
(12) Patent Application Publication
(10) Pub. No.: US 2008/0077527 A1
(43) Pub. Date: Mar. 27, 2008

(54) Method and System for a Purchase Transaction at a Remote Merchant Machine

(75) Inventors: Howon Choe, Richardson, TX (US); Min Park, Garland, TX (US)

Correspondence Address: HAYNES AND BOONE, LLP, 901 Main Street, Suite 3100, Dallas, TX, 75202, US

(73) Assignee: MOBILEKASH, INC., Richardson, TX (US)

(21) Appl. No.: 11/747,690

(22) Filed: May 11, 2007

Related U.S. Application Data
(60) Provisional application No. 60/826,411, filed on Sep. 21, 2006.

(51) Int. Cl. G06Q 30/00; G06Q 90/00

(52) U.S. Cl. 705/44

(57) ABSTRACT

A method comprises receiving, at a payment media interface associated with a remote merchant machine, a signal from a mobile customer premise device. The mobile customer premise device includes a set of device identification data. In response to receiving the signal, the remote merchant machine communicates a remote merchant machine identification code to the mobile customer premise device. The method further comprises receiving, through a network interface of the remote merchant machine, a purchase authorization and customer account data from a payment processing system. The customer account data is accessed by the payment processing system based upon receiving at least a portion of the remote merchant machine identification code from the mobile customer premise device and at least a portion of the device identification data from the mobile customer premise device The method further comprises receiving a selection input corresponding to a selected item, dispensing the selected item and creating a transaction record. At least a portion of the transaction record is communicated to the payment processing system.

### CROSS-REFERENCE

This application claims priority from U.S. Provisional Patent Application Ser. No. 60/826,411 filed on Sep. 21, 2006, the disclosure of which is incorporated by reference.

### BACKGROUND

Vending machines and other remote merchant machines are frequently equipped to accept cash and/or read credit, debit, or smart cards to allow a user to conduct purchase transactions. To process credit card purchases, the machine may be programmed to initiate a communication with a networked processing center for each purchase transaction. This method may require a private network and wired connections for a telephone or Ethernet connection to send payment data for processing and verification. Providing wired connections to many remote merchant machines may be costly and impracticable, if not impossible. Other systems use wireless communication between a remote merchant machine and the processing center to transfer sensitive information such as credit card data. This type of system carries the risk that the credit card information may be intercepted and obtained by a third party during the wireless transmission. The associated security risk may make this type of system unsatisfactory.

### SUMMARY

In one embodiment, a method comprises receiving, at a payment media interface associated with a remote merchant machine, a signal from a mobile customer premise device. The mobile customer premise device includes a set of device identification data. In response to receiving the signal, the remote merchant machine communicates a remote merchant machine identification code to the mobile customer premise device. The method further comprises receiving, through a network interface of the remote merchant machine, a purchase authorization and customer account data from a payment processing system. The customer account data is accessed by the payment processing system based upon receiving at least a portion of the remote merchant machine identification code from the mobile customer premise device and at least a portion of the device identification data from the mobile customer premise device The method further comprises receiving a selection input corresponding to a selected item, dispensing the selected item and creating a transaction record. At least a portion of the transaction record is communicated to the payment processing system.

In another embodiment, a method comprises receiving a remote merchant machine identification code associated with a remote merchant machine from a mobile customer premise device over a first network. The remote merchant machine identification data was obtained by the mobile customer premise device in response to sending a signal from the mobile customer premise device to a payment media interface associated with the remote merchant machine. The method further comprises receiving device identification data associated with the mobile customer premise device from the mobile customer premise device and authenticating the device identification data. The method further comprises communicating at least a portion of the device identification data to a customer account database and receiving access to customer account data associated with the device identification data. The method further comprises generating a purchase authorization and communicating the purchase authorization to the remote merchant machine over the second network. The method further comprises communicating at least a portion of the customer account data to the remote merchant machine over a second network and receiving from the remote merchant machine a record of sale generated by the remote merchant machine.

In still another embodiment, a payment processing system comprises a payment processing server and an interface adapted to connect the payment processing server to a communications network. The system further includes an inbound communications module adapted to receive remote merchant machine identification data associated with a remote merchant machine from a mobile customer premise device. The remote merchant machine identification data was obtained by the mobile customer premise device in response to sending a signal from the mobile customer premise device to a payment media interface associated with the remote merchant machine. The inbound communications module is also adapted to receive device identification data associated with the mobile customer premise device from the mobile customer premise device. The system further includes an authentication module adapted to authenticate the device identification data and a data retrieval module adapted to access a customer account database to receive access to customer account data associated with the device identification data. The system further includes an authorization generator adapted to generate a purchase authorization. The system also includes a merchant communications module adapted to communicate at least a portion of the customer account data to the remote merchant machine, to communicate the purchase authorization to the remote merchant machine, and to receive from the remote merchant machine a record of sale generated by the remote merchant machine.

Additional and alternative features, advantages, uses and embodiments are set forth in or will be apparent from the following description, drawings, and claims.

### BRIEF DESCRIPTION OF THE DRAWINGS

FIG. 1 provides a block diagram of a remote purchasing system employing one embodiment of the present invention.

FIG. 2 provides a block diagram of a remote purchasing system employing another embodiment of the present invention.

FIG. 3 provides a flowchart of a remote purchasing method employing one embodiment of the present invention.

### DESCRIPTION

The present disclosure relates generally to systems and methods for remote merchant machine purchases and, more particularly in some embodiments, to systems and methods for remote merchant machine purchasing using wireless customer premise equipment. For the purposes of promoting an understanding of the principles of the invention, reference will now be made to embodiments or examples illustrated in the drawings, and specific language will be used to describe the same. It will nevertheless be understood that no limitation of the scope of the invention is thereby intended. Any alteration and further modifications in the described embodiments, and any further applications of the principles of the invention as described herein are contemplated as would normally occur to one skilled in the art to which the disclosure relates.

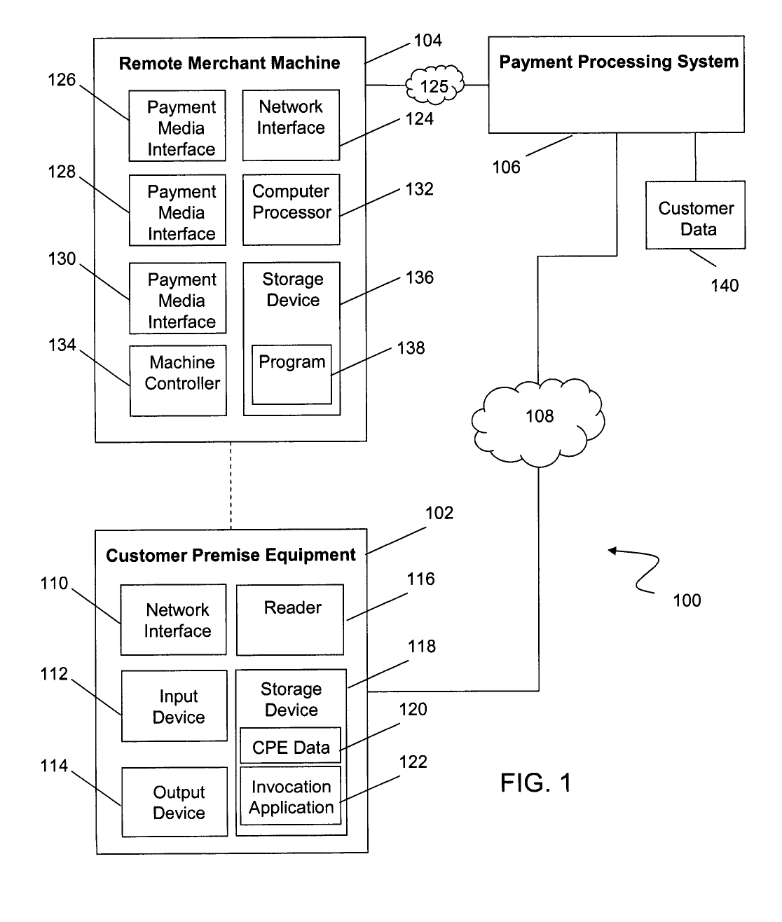

Referring first to FIG. 1, the numeral 100 refers to one embodiment of a remote purchasing system. The system 100 comprises customer premise equipment (“CPE”) 102 also known as a customer premise device, a remote merchant machine (“RMM”) 104, and a payment processing system (“PPS”) 106. The remote purchasing system 100 may provide a convenient and secure system for users to pay for purchases using their wireless CPE's without the use of cash or credit cards at the point of sale.

The CPE 102 may be a mobile phone, a personal data assistant (“PDA”), a personal computer, or any other wireless device or equipment which has an account established with a network service provider to allow the CPE 102 to become wirelessly connected to a communication network 108, which in this embodiment may be any public network including voice, data, and/or video networks. The network may include the Internet. In alternative embodiments, all or portions of the network 108 may be private.

In this embodiment, the CPE 102 includes a network interface 110 for connecting and maintaining a communications link with the network 108 via a communications method such as Interactive Voice Response (“IVR”), Wireless Application Protocol (“WAP”), Unstructured Supplementary Service Data (“USSD”), Java 2 Platform Micro Edition (“J2ME”), Binary Runtime Environment for Wireless (“BREW”), Interactive Short Message Service (“I-SMS”), the Internet, or other communications platforms. Although this embodiment is directed toward a wireless network interface, it is understood that wired network connections may be suitable for alternative embodiments.

The CPE 102 may further include an input device 112 such as a keypad, a touch screen, or a voice recognition system for entering commands or information from the user. The CPE 102 may also include an output device 114 such as a display screen, a speaker for providing an audible sound or message, a light emitting diode (“LED”), or any other device capable of producing a visible or audible communication to a user.

The CPE 102 may also include a scanner or reader 116 for detecting and receiving information via a short-range wireless connectivity technology such as radio frequency identification (“RFID”), the Infrared Data Association standard (“IrDA”), near field communication (“NFC”) technology, the Bluetooth protocol, or barcode systems such as liquid crystal display based barcode reading systems (“LCD barcode”). The reader 116 may include a signal generator for generating a short-range wireless signal for detecting the RMM 104. The signal generator of reader 116 may be constantly on or may be selectively activated by the user of the CPE 102. As indicated in FIG. 1 by a dotted line, the link between the CPE 102 and the RMM 104 may be temporary, lasting sufficiently long for the transfer of information and terminating either upon disconnection by the user or automatically upon completion of the transfer of information. The reader 116 may be built-in to the CPE, or in other words, the CPE may be internally equipped with the reader 116. For example, the reader 116 may be a built-in barcode, smartcard, or RFID reader.

The CPE 102 may also include a memory or storage device 118 for storing CPE data 120 such as CPE device identification data. The storage device 118 may also include an invocation application 122 for invoking a remote purchasing process in response to a signal from the reader 116. The CPE 102 may also include processors and other components necessary for operating the CPE 102 according to the methods described in this disclosure.

The RMM 104 is a remote process device from which goods or services may be purchased by a user. The RMM 104 may dispense the goods or services in response to receipt of payment in the form of cash, credit/debit card, tokens, or electronic payment such as the type that will be described further in this disclosure. The RMM may be, for example, a vending machine for dispensing physical goods such as beverages or for dispensing a service such as photocopy services or wireless networking services. Other examples of RMM's include gaming machines, parking meters, parking garage gates, automated teller machines (“ATMs”), change machines, gasoline pumps, and car wash kiosks.

In this embodiment, the RMM 104 includes a network interface 124 for connecting and maintaining a communications link with the PPS 106 over a private network 125. The network 125 may be only partially private, and may include voice, data, and/or video networks. The network 125 may include the Internet. Thus, in this embodiment, communication between the RMM 104 and the PPS 106 may enjoy further security because it passes through the private network 125. The network interface 124 may support one or more communications protocols, including Short Message Service (“SMS”). As will be described in a separate embodiment, the RMM may, alternatively, be connected with the PPS over a public network. The RMM 104 further includes various payment media interfaces 126, 128, 130. Payment media interface 126 may be, for example, equipment to accept cash, including coins or bills, from a user. Payment media interface 128 may be, for example, equipment to accept and process credit card, debit card, gift card, smart card, or other types of payment cards. Payment media interface 130 may be a device for storing information about the RMM 104, including a unique RMM identification code, which is capable of being read by the CPE reader 116. The payment media interface 130 may communicate with other components of the RMM 104 and dynamically update the stored information. Alternatively, the payment media interface may comprise static stored information. Examples of a suitable interface 130 may include an RFID device, an IrDA transceiver, an NFC tag, a Bluetooth device, or a barcode. The RMM 104 may further include a computer processor 132 and a machine controller 134 for operating mechanical dispensing apparatus in the RMM 104 in response to payment authorization from any of the payment media interfaces 126, 128, 130. The RMM 104 may further include a memory or storage device 136 to store, for example, transaction data. The device 136 may also include a program 138 for operating the RMM 104 in accordance with a remote purchasing method as will be further described.

PPS 106 may be remotely located and include servers, routers, network interfaces, user interfaces, and databases for managing transaction workflow, subscriber data access, reporting, and administrative access. The PPS 106 provides authentication and payment request services within the remote purchasing system 100. The PPS 106 may be connected to a customer database 140 which includes account balance, credit balance, account privileges, or other banking or financial information related to customers of the remote purchasing system 100. In this embodiment, the customer database 140 may be integral with the PPS 106 or may be directly or privately connected to the PPS 106. As will be described further, in alternative embodiments, the customer database may be located remotely from the PPS and connected to the PPS via the a public network.

The PPS 106 may be connected by an interface to the public communications network 108 to, for example, receive a communication from the CPE 102. The PPS 106 may also include a first inbound communications module comprising software and equipment for receiving and processing information communicated by the CPE 102 or for sending information to the CPE 102. The PPS 106 may also include an authentication module comprising software and equipment for authenticating information communicated by the CPE 102. The PPS 106 may also include a data retrieval module comprising software and equipment for communicating with the customer database 140. The PPS 106 may also include an authorization generator for generating a purchase authorization based, for example, on information received from the CPE 102 and the customer database 140. The PPS 106 may also include a merchant communications module comprising software and equipment for sending communication to and receiving communications from the RMM over the private network 125.

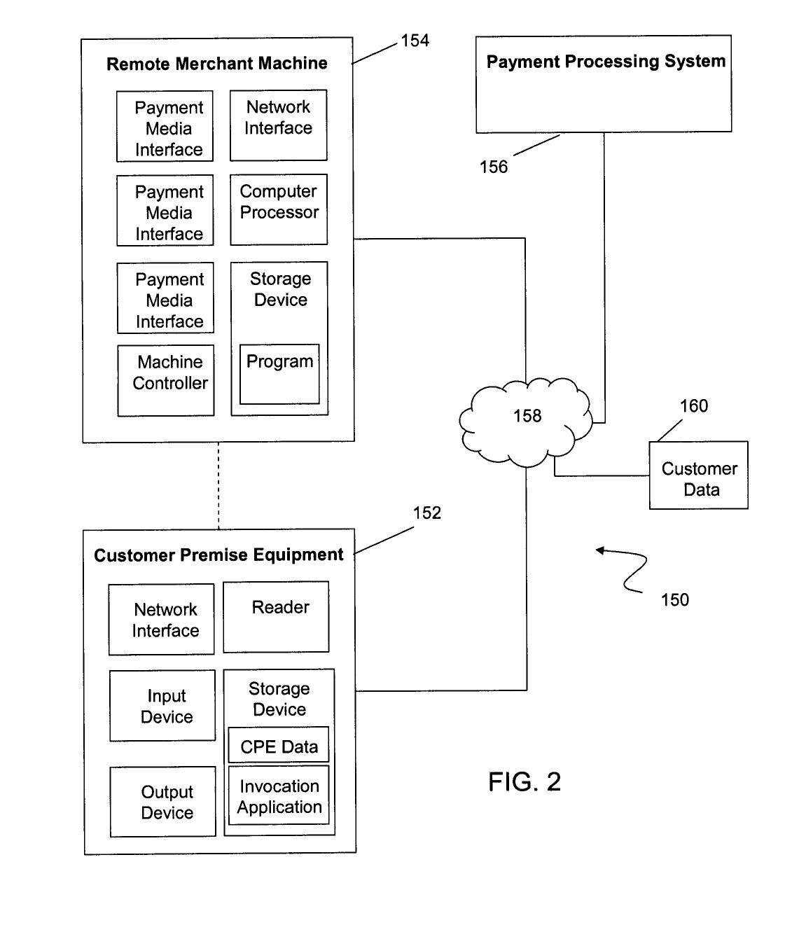

Referring now to FIG. 2, in an alternative embodiment, a remote purchasing system 150 may include a CPE 152, a RMM 154, and a PPS 156 all operable in a same or similar manner to the corresponding equipment described above, with the exceptions to be described below. The remote purchasing system 150 further includes a public communications network 158 over which the communication between the CPE 152 and the PPS 156 may be sent and also over which communication between the RMM 154 and the PPS 156 may be sent. The network 158 may be any public network including voice, data, and/or video networks. The network may include the Internet. Thus, in this embodiment, using the public network 158 for communication between the RMM 154 and the PPS 156 may provide a more economical solution than establishing a private network. To the extent that secure information is communicated between the RMM 154 and the PPS 156, encryption or other security measures known in the art may be applied. Additionally, in this embodiment, the PPS 156 may access a remote customer database 160, located, for example, at a financial institution, over the network 158.

It is understood that in alternative embodiments, a remote purchasing system may include multiple RMM's, CPE's, PPS's, and/or customer databases similar to those described above.

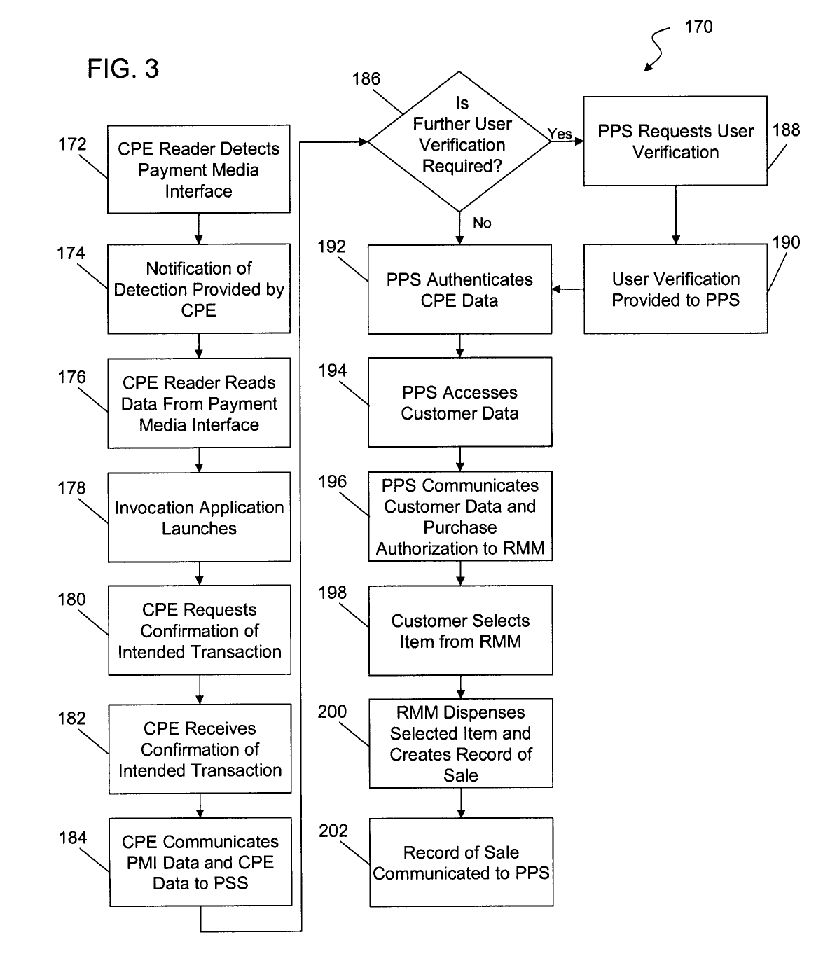

Referring now to the flowchart of FIG. 3, in this embodiment, a transaction process 170 is conducted using the remote purchasing system 100. At step 172, when a user wishes to purchase a good or a service from the RMM 104, the user may present the reader 116 of the CPE 102 to the payment media interface 130 of the RMM 104. The CPE 102 may be placed on or near the payment media interface 130. The reader 116 may provide a short-range wireless connectivity signal to the payment media interface 130 to detect the payment media interface 130. In this embodiment, physical or wired contact between the CPE 102 and the payment media interface 130 is not required.

At step 174, after the reader 116 has detected the payment media interface 130, the CPE 102 provides an audible or visible notification to the user via the output device 114. At step 176, the reader 116 retrieves RMM information about the RMM from the payment media interface 130. The retrieved RMM information may include static identification such as a code unique to the RMM, the type of goods or services dispensed by the RMM, and the location of the RMM. The retrieved information may also include dynamic information such as the quantity of goods or services remaining to dispense and the price of the goods or services. The RMM identification code may also be a dynamic code unique to the RMM at a specific time. It is understood that the notification step can occur either before or after the information is read from the payment media interface 130. The link between the CPE 102 and the RMM 104 may be temporary, lasting sufficiently long for the transfer of information and terminating either upon disconnection by the user or automatically upon completion of the transfer of information.

In one example of a bi-directional communication short-range wireless system, the payment media interface 130 may be an RFID device, and an RFID antenna in the reader 116 may provide a radio-frequency signal to the RFID device to establish a communication link. The RFID device, which may be passive or active, may transmit a response detectable by the reader 116.

In one example of a uni-directional communication short-range wireless system, the payment media interface 130 may be a barcode, and the reader 116 may be a barcode scanner such as an LCD barcode scanner to detect and read the barcode.

In another example, near field communication (“NFC”) is used to pass information from the RMM 104 to the CPE 102. The NFC connection may be temporary and may become disabled once the required information has been communicated from the RMM 104 to the CPE 102.

At step 178, the CPE 102 launches the invocation application 122. At step 180, the invocation application 122 may request that the user provide confirmation of an intent to make a purchase. At step 182, the user may communicate the intent to the CPE 102 through the input device 112 and may also communicate a price value of a selected item or an identification code associated with a selected item.

At step 184, the invocation application 122 causes the CPE 102 to place a call to the PPS 106 via the network interface 110 over the communications network 108. In an alternative embodiment, the user may directly cause the CPE to place a call to the PPS via the network interface over the communications network. The inbound communications module of the PPS 106 may receive from the CPE 102 the RMM information retrieved from the RMM, device information identifying the CPE 102, and the information associated with the selected item(s). The device identification information for the CPE 102 may be “caller ID” data such as the phone number associated with the CPE 102, but other device identification information associated with the user or with the CPE 102 may be sent.

At step 186, the authentication module of the PPS 106 may determine if further user verification is required to process the transaction. At step 188, if further user verification is required, the PPS 106 communicates, for example by a call back or text message, with the CPE 102 over the network 108 requesting a personal identification number (“PIN”) or other identifying information to be used for further verification. This request may be communicated in the form of an audible or a text message. At step 190, the user may provide the PIN or other identifying information. At step 192, the authentication module of the PPS 106 determines whether the initial device identification information and/or the PIN or other identifying information is sufficient for authentication. For example, the authentication module may compare the PIN to a stored value to determine authentication.

At step 194, if the CPE 102 information can be authenticated, the PPS 106 may access customer data located in the customer database 140. The customer database may be associated, for example, with the user's bank or mobile service provider and may be accessible over the communications network 158 as shown in FIG. 2 or, as shown in FIG. 1, may be integral with the PPS 106, directly connected with the PPS 106, or connected to the PPS over a private network. The accessed customer data may include a debit account balance, a credit account balance, a prepaid account balance, a stored value balance, a mobile communications account balance, financial institution account information, account privileges, and/or other financial information associated with the user.

At step 196, the PPS 106 communicates a purchase authorization and all or a portion of the customer data to the RMM either via the public communications network 158 as shown in FIG. 2 or over the private communications network 125 as shown in FIG. 1. The communication by the PPS to the RMM may be in the form of a secure SMS text message. In alternative embodiments, the communication by the PPS to the RMM may be sent using other telecommunications protocols known in the art.

At step 198, the RMM 106 may allow the customer to select the items to be dispensed. The customer and authorization data provide by the SMS message may allow the RMM to display a personalized greeting and/or an account balance. At step 200, the RMM 104 may dispense the selected good or service and create a record of the sale. In alternative embodiments, the RMM may dispense goods or services based upon a selection made via the CPE and transmitted to the RMM via the PPS. At step 202, the RMM may communicate, via SMS message or an alternative protocol, the record of sale to the PPS either over the public network 158 as shown in FIG. 2 or over the private network 125 as shown in FIG. 1. The PPS, upon receiving the record of sale, may settle the user's accounts by updating the customer database 140 and/or causing the appropriate funds to be transferred or the user to be billed. For example, funds may be transferred from a debit account, prepaid account, or stored value account. Alternatively, a credit or mobile communications device account may be debited and a bill sent to the user.

The communication by the RMM to the PPS may occur contemporaneously with the sale transaction. In an alternative embodiment, the RMM may collect multiple records from multiple sales and communicate the multiple records in a batch to the PPS. In either embodiment, the communication session in which the record is communicated may be initiated by either the RMM or the PPS. Thus, in some embodiments the RMM may be able to initiate outward communications while the alternative embodiments, the RMM may only respond to communications initiated by the PPS. The RMM may also provide information to the PPS such as a time period vending record, information related to the functional status of the RMM, and information related to inventory. As described, the RMM 104 may be a passive component in the remote purchasing system 100, receiving control and management data with no requirement to transmit any security sensitive data such as credit card numbers. Security sensitive information, such as PIN numbers for the purpose of authentication, may be transmitted by the user's CPE 102 to the PPS 106 without involvement of the RMM 104. With the above described system, a user may avoid sending other sensitive information such as credit card numbers or key information that would allow an interceptor to gain access to the user's credit or bank accounts.

Although only a few exemplary embodiments have been described in detail above, those skilled in the art will readily appreciate that many modifications are possible in the exemplary embodiments without materially departing from the novel teachings and advantages of this disclosure. Accordingly, all such modifications and alternative are intended to be included within the scope of the invention as defined in the following claims. Those skilled in the art should also realize that such modifications and equivalent constructions or methods do not depart from the spirit and scope of the present disclosure, and that they may make various changes, substitutions, and alterations herein without departing from the spirit and scope of the present disclosure. The scope of the invention is not limited to RMM's but may also be applicable to any merchant system where good or services are purchased by a user with a wireless CPE. In the claims, any means-plus-function clauses are intended to cover the structures described herein as performing the recited function and not only structural equivalents, but also equivalent structures.

What is claimed is:

1. A method comprising:
receiving, at a payment media interface associated with a remote merchant machine, a signal from a mobile customer premise device, the mobile customer premise device including a set of device identification data;
in response to receiving the signal, communicating a remote merchant machine identification code to the mobile customer premise device;
receiving, through a network interface of the remote merchant machine, a purchase authorization and customer account data from a payment processing system, wherein the customer account data is accessed by the payment processing system based upon receiving at least a portion of the remote merchant machine identification code from the mobile customer premise device and at least a portion of the device identification data from the mobile customer premise device;
receiving a selection input corresponding to a selected item;
dispensing the selected item;
creating a transaction record; and
communicating at least a portion of the transaction record to the payment processing system.

2. The method of claim 1 wherein the signal is a short-range wireless signal for detecting a short-range wireless connectivity device associated with the payment media interface.

3. The method of claim 2 wherein the connectivity device is an RFID device.

4. The method of claim 2 wherein the connectivity device is an IrDA transceiver.

5. The method of claim 2 wherein the connectivity device is an NFC device.

6. The method of claim 2 wherein the connectivity device is a barcode.

7. The method of claim 1 wherein the step of communicating the remote merchant machine identification code to the mobile customer premise device comprises sending remote merchant machine identification data via a short-range wireless connectivity device to a reader associated with the mobile customer premise device.

8. The method of claim 1 wherein the step of receiving, through a network interface of a remote merchant machine, a purchase authorization and a customer account data from a payment processing system comprises receiving an SMS message from the payment processing system.

9. The method of claim 1 wherein the network interface is connected to a private network.

10. The method of claim 1 wherein the network interface is connected to a public network.

11. The method of claim 1 wherein the remote merchant machine is a vending machine.

12. The method of claim 1 wherein the selected item is a quantity of currency.

13. The method of claim 1 wherein the selected item is at least one photocopy.

14. The method of claim 1 wherein the selected item is a parking privilege.

15. The method of claim 1 wherein the selected item is a car wash.

16. The method of claim 1 wherein the step of communicating at least a portion of the transaction record to the payment processing system comprises transmitting an SMS message to the payment processing system.

17. The method of claim 1 further comprising establishing a link between the payment media interface associated with a remote merchant machine and the mobile customer premise device and alerting the mobile customer premise device that the link is established.

18. The method of claim 17 wherein alerting the customer premise device comprises causing the customer premise device to emit an audible notification.

19. The method of claim 17 wherein alerting the customer premise device comprises causing the customer premise device to emit a visible notification.

20. The method of claim 1 wherein the step of communicating the remote merchant machine identification code to the mobile customer premise device comprises causing the mobile customer premise device to launch an invocation application.

21. The method of claim 1 wherein the mobile customer premise device is internally equipped with a reader adapted to receive the remote merchant machine identification code.

22. The method of claim 21 wherein the reader is a barcode reader.

23. The method of claim 21 wherein the reader is an LCD barcode reader.

24. The method of claim 21 wherein the reader is a smartcard reader.

25. The method of claim 21 wherein the reader is an RFID reader.

26. The method of claim 21 wherein the reader is an NFC reader.

27. A method comprising:
receiving a remote merchant machine identification code associated with a remote merchant machine from a mobile customer premise device over a first network, wherein the remote merchant machine identification data was obtained by the mobile customer premise device in response to sending a signal from the mobile customer premise device to a payment media interface associated with the remote merchant machine;
receiving device identification data associated with the mobile customer premise device from the mobile customer premise device;
authenticating the device identification data;
communicating at least a portion of the device identification data to a customer account database;
receiving access to customer account data associated with the device identification data;
generating a purchase authorization;
communicating at least a portion of the customer account data to the remote merchant machine over a second network;
communicating the purchase authorization to the remote merchant machine over the second network; and
receiving from the remote merchant machine a record of sale generated by the remote merchant machine.

28. The method of claim 27 further comprising:
requesting user verification data from the mobile customer premise device via the first network; and
receiving the user verification data from the mobile customer premise device via the first network,
wherein the step of authenticating comprises comparing the user verification data to a stored value associated with the mobile customer premise device.

29. The method of claim 28 wherein the verification data is a personal identification number.

30. The method of claim 27 wherein the step of communicating at least a portion of the customer account data to the remote merchant machine over the second network comprises transmitting an SMS message.

31. The method of claim 27 wherein the step of communicating the purchase authorization to the remote merchant machine over the second network comprises transmitting an SMS message.

32. The method of claim 27 wherein the step of receiving from the remote merchant machine a record of sale generated by the remote merchant machine comprises receiving an SMS message.

33. The method of claim 27 wherein the second network is a private network.

34. The method of claim 27 wherein the first network is a public network.

35. The method of claim 27 wherein the step of receiving a record of sale generated by the remote merchant machine comprises receiving a plurality of records of sale sent in batch by the remote merchant machine.

36. The method of claim 27 wherein the step of communicating at least a portion of the device identification data to a customer account database comprises transmitting the at least a portion of the device identification data to a customer account database over a network.

37. The method of claim 27 further comprising:
receiving a purchase amount value corresponding to a selected item associated with the remote merchant machine from the mobile customer premise device.

38. A payment processing system comprising:
a payment processing server;
an interface adapted to connect the payment processing server to a communications network;
an inbound communications module
adapted to receive remote merchant machine identification data associated with a remote merchant machine from a mobile customer premise device, wherein the remote merchant machine identification data was obtained by the mobile customer premise device in response to sending a signal from the mobile customer premise device to a payment media interface associated with the remote merchant machine and
adapted to receive device identification data associated with the mobile customer premise device from the mobile customer premise device;
an authentication module adapted to authenticate the device identification data;
a data retrieval module adapted to access a customer account database to receive access to customer account data associated with the device identification data;
an authorization generator adapted to generate a purchase authorization;
a merchant communications module adapted to communicate at least a portion of the customer account data to the remote merchant machine, to communicate the purchase authorization to the remote merchant machine, and to receive from the remote merchant machine a record of sale generated by the remote merchant machine.

39. The system of claim 38 wherein the authentication module further comprises a submodule adapted to:
request user verification data from the mobile customer premise device; and
receive the user verification data from the mobile customer premise device,
wherein the authentication module compares the user verification data to a stored value associated with the mobile customer premise device.

40. The system of claim 39 wherein the verification data is a personal identification number.

41. The system of claim 38 wherein the merchant communications module transmits the at least a portion of the customer account data to the remote merchant machine via an SMS message.

42. The method of claim 38 wherein the merchant communications module transmits the purchase authorization to the remote merchant machine via an SMS message.

43. The method of claim 41, wherein the at least a portion of the customer account data is an account balance.

44. The method of claim 38 wherein the merchant communications module is configured to receive an SMS message from the remote merchant machine including the generated record of sale.
